(19) United States
(12) Patent Application Publication
(10) Pub. No.: US 2018/0061189 A1
(43) Pub. Date: Mar. 1, 2018

(54) ALARM EVENT DETERMINATION VIA MICROPHONE ARRAYS

(71) Applicant: Hewlett-Packard Development Company, L.P., Houston, TX (US)

(72) Inventors: Rajat Sandeshkumar ANAND, Palo Alto, CA (US); Jongwon YUK, Cupertino, CA (US); Robert J LOCKWOOD, San Diego, CA (US)

(21) Appl. No.: 15/557,015

(22) PCT Filed: May 8, 2015
(86) PCT No.: PCT/US2015/029912

§ 371 Date: Sep. 8, 2017

(51) Int. Cl. G08B 1/08; H04R 1/40; H04R 3/00; G10L 25/51; G08B 27/00

(52) U.S. Cl. CPC G08B 1/08; H04R 1/406; G08B 27/00; G10L 25/51; H04R 3/005

(57) ABSTRACT

Examples disclosed herein provide the ability to communicate alarm events on a premises to client devices remotely located with respect to the premises. In one example, a monitoring device extracts a sound originating from the premises, wherein the sound is detected by microphones of a microphone array. The monitoring device performs pattern matching to identify an alarm event associated with the extracted sound, and determines a location of the alarm event within the premises based on information obtained individually by the microphones of the microphone array. The monitoring device communicates the alarm event and the location of the alarm event to a client device remotely located with respect to the premises.

### BACKGROUND

Alarm sensing devices may be used on a premises for monitoring various emergency, safety, and health conditions. For example, an alarm sensing device or sensor can include a smoke alarm detector that issues an alarm when smoke reaches a level indicative of a hazardous fire. Other alarm sensors may detect a burglar intrusion or other invasion when a window is broken or opened unexpectedly, or may sense carbon monoxide or some other condition, hazard, or parameter that may warrant issuing an alarm. As an example, such alarm sensors can be located at a premises, for example, attached to a wall or ceiling of a building, such as a home or office. When a parameter warranting an alarm arises, an alarm sensor may sound an alarm local to the site of the detected condition.

### BRIEF DESCRIPTION OF THE DRAWINGS

FIG. 1 is a block diagram illustrating a monitoring device with an array of microphones having the ability to detect and identify the location of an alarm event within a premises, according to an example;

FIGS. 2A-B illustrate the monitoring device within a premises, having the ability to identify the location of alarms events in different areas of the premises, according to an example; and

FIG. 3 is a flow diagram in accordance with an example of the present disclosure.

### DETAILED DESCRIPTION

Damages from hazards can be limited if prompt notification is given when they occur. As people may not be located on a premises when an alarm is sounded, damages from the hazard condition triggering the alarm may be unavoidable.

Examples disclosed herein provide the ability to send notifications regarding hazard conditions on a premises, for receipt offsite of the premises. As an example, the recipient of the notification may comprise a smartphone or other handheld cellular device or client device carried by an owner of the premises who may be at work or on vacation, for example. In other examples, the recipient of the notification may comprise a server that is located offsite of the premises and that forwards the notification to a central monitoring station, to a cellular handheld device, or to some other recipient, for example. As will be further described, as various hazard conditions may arise on a premises, and in various locations on the premises, notifications regarding a hazard condition may specify the particular condition, and the location of the condition on the premises, so that appropriate action may be taken to limit any potential damages on the premises.

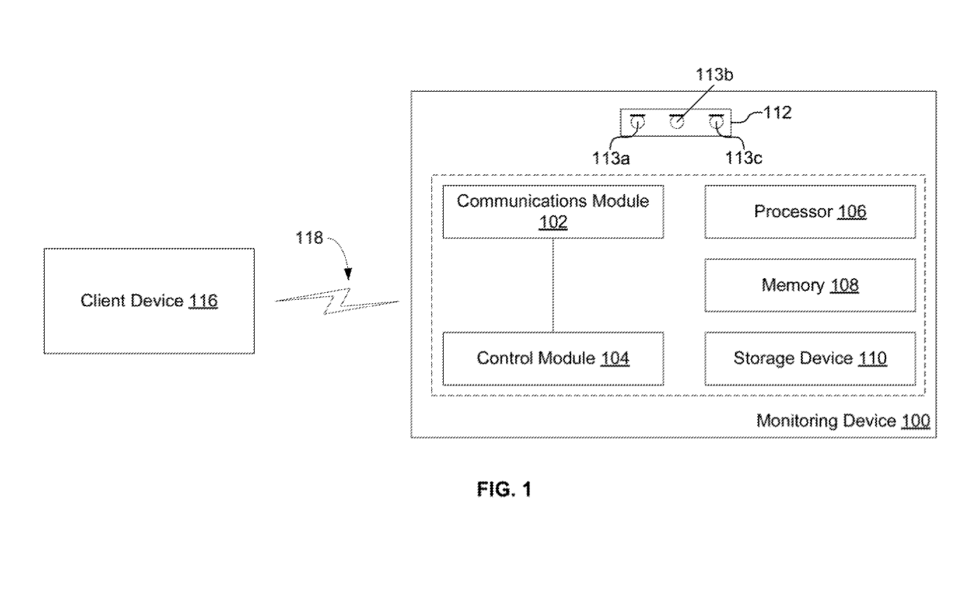

With reference to the figures, FIG. 1 is a block diagram illustrating a monitoring device 100 with an array 112 of microphones 113a-113c having the ability to detect and identify the location of an alarm event within a premises, according to an example. By utilizing the array 112 of microphones 113a-113c, the directionality of a sound originating from an alarm sensing device associated with an alarm event may be determined. The arrangement of the array 112 on the monitoring device 100, and the number of microphones in the array 112, may vary. Therefore, although three microphones 113a-113c are illustrated in the array 112, any number of microphones may be utilized in the array 112. As an example, the monitoring device 100 may include a microphone on each end of the device 100. As will be further described, the spacing and quantity of the microphones in the array 112 may impact the accuracy of determining the directionality of a sound originating from an alarm sensing device.

Upon detecting and identifying the location of an alarm event within the premises, the monitoring device 100 may communicate information concerning the alarm event to a client device 116, as will be further described. For example, the monitoring device 100 may initiate a text message, email, or phone call to the client device 116. As an example, the monitoring device 100 may include a communications module 102 to enable the monitoring device 100 to communicate information to the client device 116, according to an example. As an example, the communications module 102 may include an antenna (not illustrated) to allow for transmission and receipt of wireless signals. The communications module 102 can include a transceiver for transmitting and receiving signals.

As an example, the client device 116 may be disposed remote from the monitoring device 100, or remotely located with respect to the premises where the monitoring device 100 is located. The monitoring device 100 and the client device 116 may exchange communications with each other via wireless signals 118. In some examples, the client device 116 may be a smartphone or other handheld cellular device or client device carried by an owner of the premises who may be at work or on vacation, for example. The monitoring device 100 may include one or more communications modules 102 for communicating with different radio communication systems, such as a Wi-Fi router and/or a cell phone station.

The monitoring device 100 includes a processor 106 and a storage device 110. The components of the monitoring device 100 may be connected and communicate through a system bus (e.g., PCI, ISA, PCI-Express, HyperTransport®, NuBus, etc.). The processor 106 can be a single core processor, a multi-core processor, a computing cluster, or any number of other configurations. The processor 106 may be implemented as Complex Instruction Set Computer (CISC) or Reduced Instruction Set Computer (RISC) processors, x86 Instruction set compatible processors, multi-core, or any other microprocessor or central processing unit (CPU). As an example, the main processor 106 includes dual-core processor(s), dual-core mobile processor(s), or the like.

The monitoring device 100 may include a memory device 108. The memory device 108 can include random access memory (e.g., SRAM, DRAM, zero capacitor RAM, SONOS, eDRAM, EDO RAM, DDR RAM, RRAM, PRAM, etc.), read only memory (e.g., Mask ROM, PROM, EPROM, EEPROM, etc.), flash memory, or any other suitable memory systems. The storage device 110 may be a non-transitory computer-readable storage medium. The storage device 110 may have instructions stored thereon that, when executed by a processing resource, such as the processor 106, cause the monitoring device 100 to perform operations.

In some examples, the instructions can be part of an installation package that, when installed, can be executed by processing resource(s) to implement the operations. In such examples, the machine-readable storage medium may be a portable medium, such as a CD, DVD, or flash drive, or a memory maintained by a server from which the installation package can be downloaded and installed. In other examples, the instructions may be part of an application, applications, or component already installed on a server including the processing resource. In such examples, the machine-readable storage medium may include memory such as a hard drive, solid state drive, or the like. In other examples, some or all of the functionalities described may be implemented in the form of electronic circuitry.

As used herein, a “machine-readable storage medium” may be any electronic, magnetic, optical, or other physical storage apparatus to contain or store information such as executable instructions, data, and the like. For example, any machine-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.), and the like, or a combination thereof. Further, any machine-readable storage medium described herein may be non-transitory.

Referring back to FIG. 1, the operations described herein may be executed by a control module 104. The control module 104 can be implemented in hardware, implemented as machine-readable instructions executable on the processor(s) 106, or implemented as a combination of hardware and machine-readable instructions. In examples where the control module 104 is implemented at least in part with machine-readable instructions, these machine-readable instructions can be in the form of software executable on the processor(s) 106, or software or firmware executable by a processor in the communications module 102.

As will be further described, the control module 104 may extract a sound originating from a premises where the monitoring device 100 is located. As will be further described, the sound may be detected by the microphones 113a-113c of the microphone array 112. Upon extracting the sound, the control module 104 may perform a pattern matching to identify an alarm event associated with the extracted sound. Thereafter, the control module 104 may determine a location of the alarm event within the premises, and communicate the alarm event and the location of the alarm event to the client device 116.

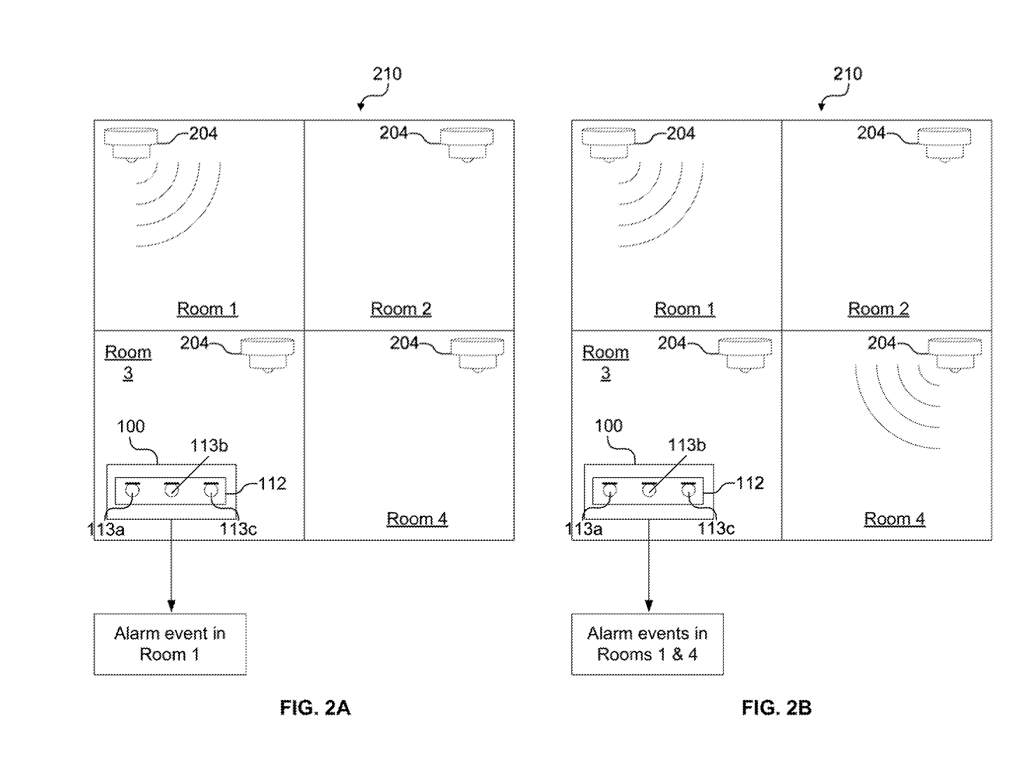

FIGS. 2A-B illustrate the monitoring device 100 with the array 112 of microphones 113a-113c having the ability to detect and identify the location of an alarm event within a premises 210, according to an example. As mentioned above, by utilizing the array 112 of microphones 113a-113c, the directionality of a sound originating from an alarm sensing device associated with an alarm event may be determined. As will be further described, this directionality may be used as a setup procedure during a setup of the device 100, to add location information to various alarm sensing devices 204 located within the premises 210, for example, if the alarm sensing devices are located in different rooms or floors within the premises 210. Upon detecting and identifying the location of an alarm event within the premises 210, the device 100 may communicate information concerning the alarm event to an appropriate client device (e.g., client device 116), as will be further described.

As illustrated, the premises 210 may include four rooms (Rooms 1-4) located on various floors. The arrangement and number of the rooms and floors may vary from what is illustrated. The monitoring device 100 for detecting and identifying the location of an alarm event with the premises 210 may be in a fixed location within the premises 210 (e.g., in Room 3, as illustrated). Each room may include alarm sensing devices 204 for monitoring various emergency, safety, and health conditions. Based on the condition detected in a room by one of the alarm sensing devices 204 (e.g., fire, burglar intrusion), the alarm sensing device 204 detecting the condition may sound an alarm corresponding to that condition. For example, if the condition is a fire, the alarm sensing device 204 may sound a first alarm that is indicative of a fire, and if the condition is a burglar intrusion, the alarm sensing device 204 may sound a second alarm that is indicative of a burglar intrusion.

In order to properly detect and identify the location of the various alarm events within the premises 210, the monitoring device 100 may go through a setup procedure for recognizing the alarm events triggered by the various alarm sensing devices 204 within the premises 210. For example, after assigning a location within the premises 210 for the monitoring device 100 (e.g., in Room 3, as illustrated), each alarm sensing device 204 within the premises 210 may be triggered to sound their respective alarms. With regards to each alarm sounded by an alarm sensing device 204, the sound detected by the microphones 113a-113c of the microphone arrays 112 may be recorded and stored in the storage device 110 of the monitoring device 100. As will be further described, after the setup procedure is complete, the monitoring device 100 may perform pattern matching to identify an actual alarm event triggered by one of the alarm sensing devices 204 by referencing these pre-recorded sounds captured during the setup procedure.

In addition to recording the sound detected by the microphones 113a-113c during the setup procedure, the array 112 of microphones 113a-113c may determine the directionality of the sound originating from each alarm sensing device 204, in order to add location information to the various alarm sensing devices 204 within the premises 210. For example, with the monitoring device 100 fixed in Room 3 of the premises 210, the directionality of the sound originating from each alarm sensing device 204 within the premises 210 may vary, allowing the monitoring device 100 to add location information to the various alarm sensing devices 204. As will be further described, in order to add location information to the various alarm sensing devices 204, various techniques may be utilized by using information obtained individually by the microphones 113a-113c of the microphone array 112.

As an example, the location of a sound originating from an alarm sensing device 204 within the premises 210 may be determined via acoustic source localization. As an example, acoustic source localization involves the task of locating the sound source, given measurements of the sound field collected by the microphones 113a-113c on the monitoring device 100 that is in a fixed location (e.g., Room 3). As an example, the sound field can be described using physical quantities like sound pressure and particle velocity. By measuring these properties, it is (indirectly) possible to obtain a source direction.

Also, given the measurements of the sound field collected by the microphones 113a-113c, the intensity of the sound detected individually by the microphones 113a-113c may help determine the location of the alarm sensing device 204 triggering the alarm event associated with the sound. For example, as the monitoring device 100 is fixed within Room 3 of the premises 210, the sound associated with an alarm event triggered by the alarm sensing device 204 in Room 3 may have a greater intensity than the sounds associated with alarm events triggered by alarm sensing devices 204 in the other rooms. Similarly, the sounds associated with alarm events triggered by the alarm sensing devices 204 may produce different levels of intensity, as the monitoring device 100 remains fixed within Room 3. As a result, the monitoring device 100 may add location information to the various alarm sensing devices 204 within the premises 210, based on the differing levels of intensities.

As an example, the location of the sound originating from an alarm sensing device 204 within the premises 210 may also be determined via beamforming techniques. For example, the beamforming effect may be achieved by using the array 112 of microphones 113a-113c. As the various alarm sensing devices 204 are located within different areas and rooms of the premises 210, the directionality of the sound generated by these various alarm sensing devices 204, as detected by the microphones 113a-113c on the monitoring device 100, may vary. For example, the sound generated by an alarm sensing device 204 may arrive at each microphone 113a-113c of the array 112 at different times. A fundamental part of beamforming is calculating the differences in arrival time of the sound between the microphones 113a-113c of the array 112. Upon calculating the differences in arrival time between the microphones 113a-113c, the location of the alarm sensing device 204 generating the sound may be inferred. As mentioned above, the spacing and quantity of the microphones in the array 112 may impact the accuracy of determining the directionality of a sound originating from an alarm sensing device 204.

As an example, once the setup procedure is complete, when an alarm sensing device 204 actually sounds an alarm indicating an alarm event, the sound detected by the monitoring device 100 may be pattern matched with one of the pre-recorded sounds (described above) in order to identify the alarm event. For example, the monitoring device 100 may receive feeds from the microphones 113a-113c, and extract sounds from the feeds in order to perform pattern matching to identify the alarm event associated with the extracted sound.

Pattern matching the extracted sound detected by the microphones 113a-113c with a pre-recorded sound stored on the monitoring device 100, for identifying an alarm event, generally includes the steps of sound recording, feature extraction, pattern matching, and a decision. With regards to feature extraction, where the sound recording may be cut into windows of equal length (e.g., frames), the physical quantities that may be analyzed include, but are not limited to, the frequency of the sound, as well as attributes such as duration, sound pressure, particle velocity, and an intensity of the sound. With regards to pattern matching, the extracted frames may be compared against the pre-recorded sounds, resulting in a matching score that may quantify the similarity in between the extracted sound detected by the microphones 113a-113c and the pre-recorded sound. As an example, the pre-recorded sound with the highest matching score may be selected in order to identify the alarm event associated with the extracted sound.

Upon identifying the alarm event associated with the extracted sound, the location of the alarm event within the premises 210 may be determined. As an example, the location of the alarm event may be determined based on information obtained individually by the microphones 113a-113c of the microphone array 112, and comparing this information with the location information recorded for the various alarm sensing devices 204 during the setup procedure described above. The information obtained individually by the microphones 113a-113c may relate to the various techniques described above, including, but not limited to, beamforming techniques or the intensity of the sound detected individually by the microphones 113a-113c of the array 112.

Upon identifying the alarm event, and the location of the alarm event within the premises 210, the monitoring device 100 may communicate this information to a client device remotely located with respect to the premises 210 (e.g., client device 116). As an example, the monitoring device 100 may initiate a text message, email, or phone call to the client device. As described above, the monitoring device 100 may include a communications module 102 to enable the monitoring device 100 to communicate information to the client device, according to an example.

The client device that is chosen to receive notifications from the monitoring device 100 may vary based on the alarm sensing device 204 that is triggered. For example, referring FIG. 2A, upon detecting an alarm event in Room 1 (e.g., indicated by the waves originating from alarm sensing device 204 in Room 1), the client device that is chosen to receive a notification concerning the alarm event may be a pre-selected user that is responsible for responding to the alarm event in Room 1. Referring to FIG. 2B, the monitoring device 100 may detect multiple alarm events, for example, in Rooms 1 and 4 (e.g., indicated by the waves originating from alarm sensing devices 204 in Rooms 1 and 4). As different users may be responsible for responding to the different alarm events, the monitoring device 100 may choose the appropriate client devices for receiving notifications regarding the alarm events.

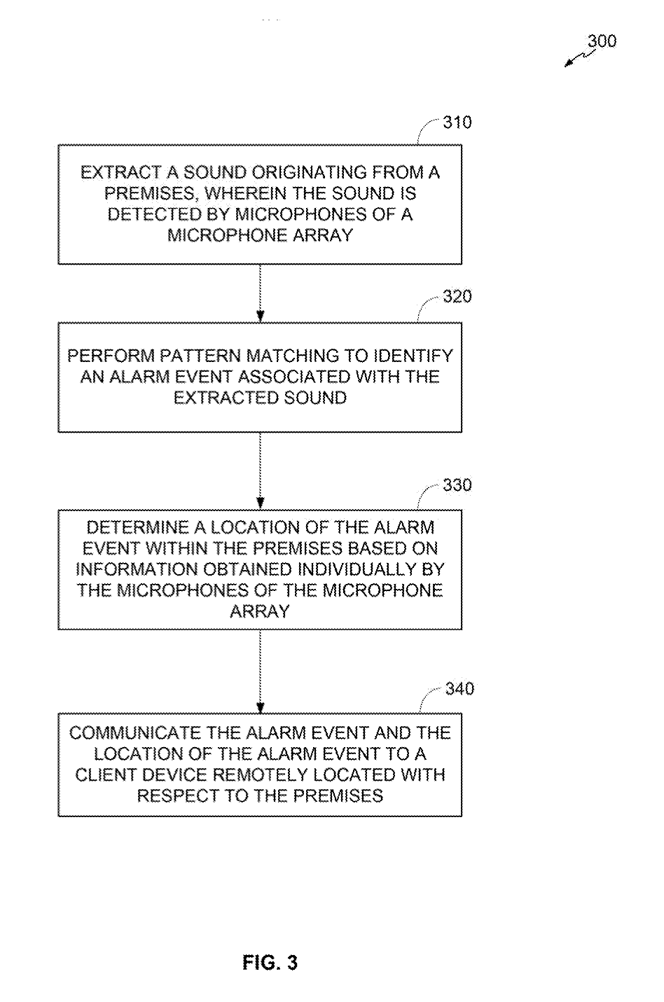

Referring to FIG. 3, a flow diagram is illustrated in accordance with various examples. The flow diagram illustrates, in a particular order, processes for communicating alarm events on a premises to client devices remotely located with respect to the premises. The order of the processes is not meant to limit the disclosure. Rather, it is expressly intended that one or more of the processes may occur in other orders or simultaneously. The disclosure is not to be limited to a particular example.

A method 300 may begin and progress to 310, where a monitoring device located on the premises may extract a sound originating from the premises. As an example, the sound may be detected by microphones of a microphone array. The sound detected by the microphones of the microphone array may include physical quantities, such as sound pressure and particle velocity.

Progressing to 320, the monitoring device may perform pattern matching to identify an alarm event associated with the extracted sound. As an example, the extracted sound may be compared to pre-recorded sounds associated with different alarm events. As described above, pattern matching the extracted sound detected by the microphones of the microphone array with a pre-recorded sound, for identifying an alarm event, generally includes the steps of sound recording, feature extraction, pattern matching, and a decision.

Progressing to 330, the monitoring device may determine a location of the alarm event within the premises based on information obtained individually by the microphones of the microphone array. The information obtained individually by the microphones of the microphone array may relate to the various techniques described above, including, but not limited to, beamforming techniques or the intensity of the sound detected individually by the microphones of the microphone array. As an example, the monitoring device may determine the location of the alarm event within the premises by measuring the physical quantities obtained individually by the microphones of the microphone array in order to obtain a source direction of the extracted sound. As an example, the monitoring device may also determine the location of the alarm event within the premises based on an intensity of the sound detected individually by the microphones of the microphone array.

With regards to beamforming techniques, the monitoring device may determine the location of the alarm event within the premises by determining a time of arrival of the sound at each microphone of the microphone array, and calculating a difference in the time of arrival of the sound at each microphone of the microphone array.

Progressing to 340, the monitoring device may communicate the alarm event and the location of the alarm event to a client device remotely located with respect to the premises. As an example, the communication may include a text message, email, or phone call to the client device. Based on the number of alarm events detected by the monitoring device, multiple client devices may be contacted for notification purposes.

It is appreciated that examples described may include various components and features. It is also appreciated that numerous specific details are set forth to provide a thorough understanding of the examples. However, it is appreciated that the examples may be practiced without limitations to these specific details. In other instances, well known methods and structures may not be described in detail to avoid unnecessarily obscuring the description of the examples. Also, the examples may be used in combination with each other.

Reference in the specification to “an example” or similar language means that a particular feature, structure, or characteristic described in connection with the example is included in at least one example, but not necessarily in other examples. The various instances of the phrase “in one example” or similar phrases in various places in the specification are not necessarily all referring to the same example.

It is appreciated that the previous description of the disclosed examples is provided to enable any person skilled in the art to make or use the present disclosure. Various modifications to these examples will be readily apparent to those skilled in the art, and the generic principles defined herein may be applied to other examples without departing from the spirit or scope of the disclosure. Thus, the present disclosure is not intended to be limited to the examples shown herein but is to be accorded the widest scope consistent with the principles and novel features disclosed herein.

What is claimed is:

1. A method comprising:
extracting a sound originating from a premises, wherein the sound is detected by microphones of a microphone array;
performing pattern matching to identify an alarm event associated with the extracted sound;
determining a location of the alarm event within the premises based on information obtained individually by the microphones of the microphone array; and
communicating the alarm event and the location of the alarm event to a client device remotely located with respect to the premises.

2. The method of claim 1, wherein performing the pattern matching comprises comparing the extracted sound to pre-recorded sounds associated with different alarm events.

3. The method of claim 1, wherein the sound detected by the microphones of the microphone array include physical quantities comprising sound pressure and particle velocity.

4. The method of claim 3, wherein determining the location of the alarm event within the premises comprises measuring the physical quantities obtained individually by the microphones of the microphone array in order to obtain a source direction of the extracted sound.

5. The method of claim 1, wherein determining the location of the alarm event within the premises is based on an intensity of the sound detected individually by the microphones of the microphone array.

6. The method of claim 1, wherein determining the location of the alarm event within the premises comprises:
determining a time of arrival of the sound at each microphone of the microphone array; and
calculating a difference in the time of arrival of the sound at each microphone of the microphone array.

7. The method of claim 1, wherein communicating the alarm event comprises initiating a text message, email, or phone call to the client device.

8. A monitoring device comprising:
an array of microphones;
a storage device;
a communications module; and
a control module to:
extract, by the array of microphones, a sound originating from a premises;
perform pattern matching to identify an alarm event associated with the extracted sound by comparing the extracted sound to pre-recorded sounds stored on the storage device;
determine a location of the alarm event within the premises based on information obtained individually by microphones of the array of microphones; and
communicate, by the communications module, the alarm event and the location of the alarm event to a client device remotely located with respect to the premises.

9. The monitoring device of claim 8, wherein the control module is to determine the location of the alarm event within the premises by measuring physical quantities obtained individually by the microphones in order to obtain a source direction of the extracted sound.

10. The monitoring device of claim 8, wherein the control module is to determine the location of the alarm event within the premises based on an intensity of the sound detected individually by the microphones.

11. The monitoring device of claim 8, wherein the control module is to determine the location of the alarm event within the premises by:
determining a time of arrival of the sound at each of the microphones; and
calculating a difference in the time of arrival of the sound at each of the microphones.

12. The monitoring device of claim 8, wherein the control module is to communicate the alarm event by initiating a text message, email, or phone call to the client device.

13. A computer-readable storage medium comprising instructions which, when executed by a processing resource, to cause the processing resource to:
extract a sound originating from a premises, wherein the sound is detected by microphones of a microphone array;
perform pattern matching to identify an alarm event associated with the extracted sound;
determine a location of the alarm event within the premises based on an intensity of the sound detected individually by the microphones of the microphone array; and
communicate the alarm event and the location of the alarm event to a client device remotely located with respect to the premises.

14. The computer-readable storage medium of claim 13, wherein the instructions to perform the pattern matching comprises instructions to compare the extracted sound to pre-recorded sounds associated with different alarm events.

15. The computer-readable storage medium of claim 13, wherein the instructions to communicate the alarm event comprises instructions to initiate a text message, email, or phone call to the client device.
